(19) United States
(12) Patent Application Publication
(10) Pub. No.: US 2005/0053772 A1
(43) Pub. Date: Mar. 10, 2005

(54) Wiring board and multilayer wiring board

(76) Inventors: Hideo Aoki, Yokohama-shi (JP); Naoko Yamaguchi, Yokohama-shi (JP); Chiaki Takubo, Tokyo (JP)

Correspondence Address: Finnegan, Henderson, Farabow,;Garrett & Dunner, L.L.P., 1300 I Street, N.W., Washington, DC, 20005-3315, US

(21) Appl. No.: 10/896,054

(22) Filed: Jul. 22, 2004

(30) Foreign Application Priority Data
Jul. 28, 2003 (JP) P2003-280699

(51) Int. Cl. B32B 3/00; B32B 15/08

(52) U.S. Cl. 428/209

(57) ABSTRACT

A wiring board formed by an electrophotographic system of transferring a visible image to a substrate, the wiring board including: a substrate to which a visible image is transferred; a nonconductive metal-containing resin layer selectively formed on the substrate and containing metal particulates dispersed therein; a conductive conductor metal layer formed on the metal-containing resin layer; and a resin layer formed contiguously to the metal-containing resin layer on the substrate.

### CROSSREFERENCE TO RELATED APPLICATIONS

This application is based upon and claims the benefit of priority from the prior Japanese Patent Application No. 2003-280699, filed on Jul. 28, 2003; the entire contents of which are incorporated herein by reference.

### BACKGROUND

1. Field of the Invention

The present invention relates to a wiring board and a multilayer wiring board formed by an electrophotographic system.

2. Description of the Related Art

Conventionally, a screen printing system has been in wide use as a method for forming a circuit pattern on a substrate constituting a wiring board and a multilayer wiring board. This screen printing system applies a paste on the substrate in a predetermined circuit pattern, the paste being made by mixing metal powder of silver (Ag), platinum (Pt), copper (Cu), palladium (Pd) or the like with a binder such as ethyl cellulose and adjusting the viscosity of the resultant mixture using a solvent such as terpineol, tetralin, butyl carbitol or the like.

This screen printing system, however, requires preparation-of a dedicated mask corresponding to each circuit pattern, bringing about a problem that multilayer wiring boards, in particular, which are likely to be put into diversified small-quantity production require many kinds of dedicated masks, resulting in longer period for producing the masks as well as considerable cost for manufacturing the multilayer wiring boards. There is another problem that a dedicated mask needs to be produced again even for a partial change in the circuit pattern, failing to take flexible response to such a change.

To solve the above-described problems of the screen printing system, a method of forming a circuit pattern on a substrate by the electrophotographic system has been developed in recent years. In this circuit pattern forming method by the electrophotographic system, an electrostatic latent image in a predetermined pattern is formed on a photoreceptor, and particles composed of insulating resin with metal particles attached to the surface thereof are brought into electrostatic adhesion with this electrostatic latent image to form a visible image, which is transferred onto the substrate to form the circuit pattern.

With such an electrophotographic system, however, it is impossible in principle to impart an electrification property to the conductive metal particles attached to the surface of the insulating resin. Further, in this electrophotographic system, it is possible to impart the electrification property to them if the surface of the insulating resin is formed of a metal oxide film, but the formation of a highly-precise conductive circuit pattern has been difficult due to extreme difficulty in adjusting the thickness and quality of the oxide film and controlling the quantity of electric charges.

As described above, in forming the conductive circuit pattern using the electrophotographic system, conductivity and imparting of the electrification property are in a trade-off relation, which has posed such a problem that it is difficult to obtain predetermined conductivity while keeping the electrification property. Especially, in order to form a microscopic pattern such as a circuit pattern with high precision, controlling the electrification property is extremely important, but the industrial production of a conductive resin layer which can achieve both high precision in circuit formation and good electric characteristics has been extremely difficult.

The present invention has been developed to solve the above-described problems, and its object is to provide a wiring board and a multilayer wiring board in which a highly-precise conductive circuit pattern on a substrate and a conductor layer of the conductive circuit pattern can be formed in a good state and which can be reduced in cost and put into diversified small-quantity production.

### BRIEF SUMMARY OF THE INVENTION

According to an aspect of the present invention, a wiring board formed by an electrophotographic system of transferring a visible image to a substrate is provided which comprises: a substrate to which a visible image is transferred; a nonconductive metal-containing resin layer selectively formed on said substrate and containing metal particulates dispersed therein; a conductive conductor metal layer formed on said metal-containing resin layer; and a resin layer formed contiguously to said metal-containing resin layer on said substrate.

According to another aspect of the present invention, a multilayer wiring board formed by an electrophotographic system of transferring a visible image to a substrate is provided which comprises: a substrate to which a visible image is transferred; a first nonconductive metal-containing resin layer selectively formed on said substrate and containing metal particulates dispersed therein; a first conductive conductor metal layer formed on said first metal-containing resin layer; a first resin layer formed contiguously to said first metal-containing resin layer on said substrate, and on said first conductor metal layer; a first conductor portion formed in a recessed portion which is constituted by a surface of said first conductor metal layer as a bottom face and said first resin layer as a side face; a second nonconductive metal-containing resin layer selectively formed on said first resin layer and on said first conductor portion and containing metal particulates dispersed therein; a second conductive conductor metal layer formed extending from a top of said second metal-containing resin layer to a top of said first conductor portion; a second resin layer formed contiguously to said second metal-containing resin layer on said first resin layer, and on said second conductor metal layer; and a second conductor portion formed in a recessed portion which is constituted by a surface of said second conductor metal layer as a bottom face and said second resin layer as a side face.

According to still another aspect of the present invention, a multilayer wiring board formed by an electrophotographic system of transferring a visible image to a substrate is provided which comprises: a substrate which is formed with a through hole at a predetermined position and to which a visible image is transferred; a first nonconductive metal-containing resin layer selectively formed at least on one face of said substrate and containing metal particulates dispersed therein; a first conductive conductor metal layer formed on said first metal-containing resin layer; a first conductor portion which electrically connects said first conductor metal layer formed on the one face of said substrate to another side of said substrate through said through hole; a first resin layer formed contiguously to said first metal-containing resin layer on said substrate, and on said first conductor portion; a second conductor portion formed in a recessed portion which is constituted by a surface of said first conductor metal layer as a bottom face and said first resin layer as a side face; a second nonconductive metal-containing resin layer selectively formed on said first resin layer and on said second conductor portion and containing metal particulates dispersed therein; a second conductive conductor metal layer formed extending from a top of said second metal-containing resin layer to a top of said second conductor portion; a second resin layer formed contiguously to said second metal-containing resin layer on said first resin layer, and on said second conductor metal layer; and a third conductor portion formed in a recessed portion which is constituted by a surface of said second conductor metal layer as a bottom face and said second resin layer as a side face.

### BRIEF DESCRIPTION OF THE DRAWINGS

The present invention will be described with reference to drawings, but these drawings are provided only for the illustrative purpose and not intended to limit the invention in any respect.

FIG. 1 is a cross-sectional view schematically showing a wiring board of a first embodiment of embodiments of the present invention.

FIG. 2 is a view schematically showing the forming process of a conductor pattern in the first embodiment of the embodiments of the present invention.

FIG. 3 is a view schematically showing the forming process of an insulating pattern in the first embodiment of the embodiments of the present invention.

FIG. 4 is a cross-sectional view schematically showing an example of the structure of a metal-containing resin particle.

FIG. 5 is a chart showing the relation between the quantity of electric charges and the content of copper contained in the metal-containing resin particle.

FIG. 6 is a cross-sectional view schematically showing a multilayer wiring board of a second embodiment of the embodiments of the present invention.

FIGS. 7A to 7C are plan views schematically showing examples of the shape of a metal-containing resin layer formed on a via layer.

FIGS. 8A to 8G are views schematically showing the forming process of a conductor pattern or the forming process of an insulating pattern in the second embodiment of the embodiments of the present invention.

FIG. 9 is a cross-sectional view schematically showing another example of the multilayer wiring board of the second embodiment of the embodiments of the present invention.

FIG. 10 is a cross-sectional view schematically showing a multilayer wiring board of a third embodiment of the embodiments of the present invention.

FIGS. 11A to 11D are views schematically showing the forming process of a conductor pattern or the forming process of an insulating pattern in the third embodiment of the embodiments of the present invention.

### DETAILED DESCRIPTION OF THE INVENTION

Hereinafter, embodiments of the present invention will be described with reference to the drawings.

(First Embodiment)

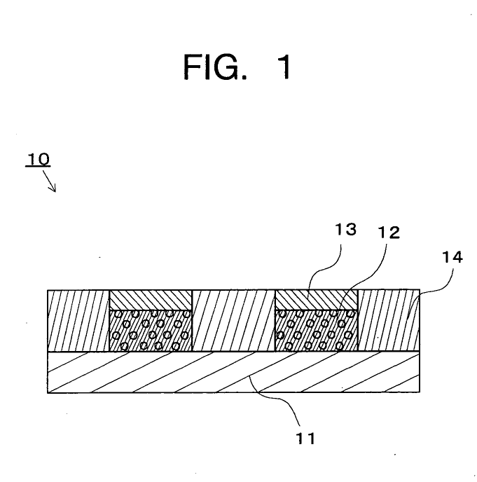

FIG. 1 schematically shows a cross-sectional view of a wiring board 10 composed of a single layer of the first embodiment of the present invention.

The wiring board 10 is composed of a base material 11, a nonconductive metal-containing resin layer 12 selectively formed on the base material 11, a conductive conductor metal layer 13 formed on the metal-containing resin layer 12, and a resin layer 14 selectively formed on the base material 11.

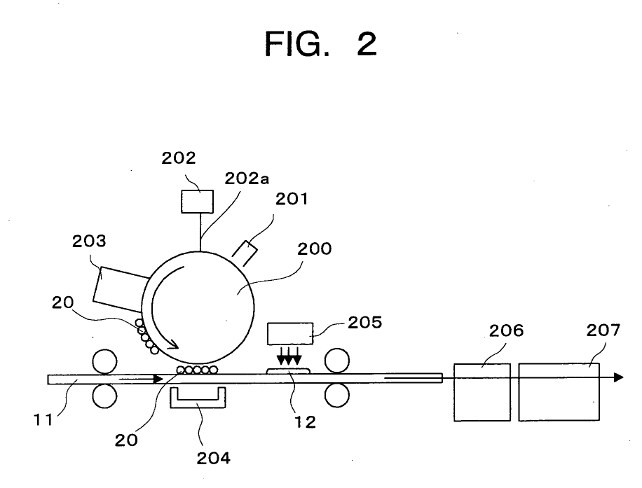

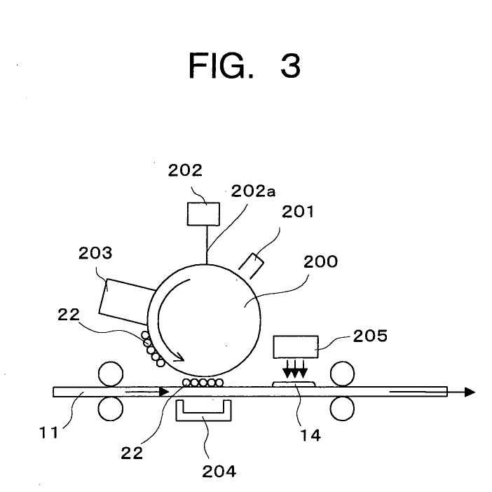

An example of the forming process of the wiring board 10 will be described with reference to FIG. 2 and FIG. 3.

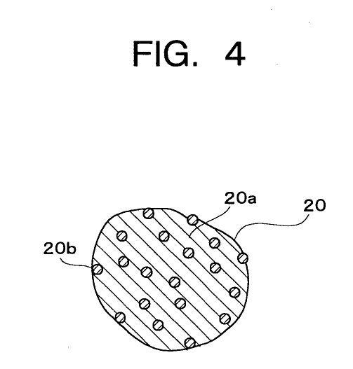

FIG. 2 is a view schematically showing the forming process of a conductor pattern of the first embodiment of the present invention. FIG. 3 is a view schematically showing the forming process of an insulating pattern of the first embodiment. Further, FIG. 4 shows a cross-sectional view schematically showing a metal-containing resin particle 20 forming the nonconductive metal-containing resin layer 12 for forming the conductor pattern.

A manufacturing apparatus for forming the conductor pattern or the insulating pattern shown in FIG. 2 or FIG. 3 is essentially composed of a photosensitive drum 200, an electrifier 201, a laser generation/scan unit 202, a developing unit 203, a transfer unit 204, the base material 11 for forming the wiring board, a resin curing unit 205 by heating or light irradiation, a resin etching unit 206, and an electroless plating tank 207.

Next, the forming process of the conductor pattern will be described referring to FIG. 2.

The photosensitive drum 200 is first uniformly charged, by the electrifier 201, while being rotated in a direction with an arrow so that its surface has a certain potential (for example, minus charges). Concrete charging methods include a scorotron charging method, a roller charging method, a brush charging method, and the like. Next, the laser generation/scan unit 202 irradiates the photosensitive drum 200 with a laser light 202a in accordance with an image signal to remove the minus charges on a portion irradiated, thereby forming an image of charges (electrostatic latent image) in a predetermined pattern on the surface of the photosensitive drum 200.

Next, to the electrostatic latent image on the photosensitive drum 200, charged metal-containing resin particles 20 stored in the developing unit 203 are electrostatically attached by a supply mechanism to form a visible image. In this event, charged area development or reversal development can be employed. As the developing unit 203, a dry or wet toner transfer technique in a well-known electrophotographic copying system is applicable.

When the developing unit 203 is of the dry type, it stores therein the metal-containing resin particles 20 with a diameter of 3 μm to 50 μm. The diameter of the metal-containing resin particles 20 is more preferably 5 μm to 10 μm. On the other hand, when the developing unit 203 is of the wet type, it stores therein the metal-containing resin particles 20 with a diameter of 3 μm or smaller.

B-stage thermosetting resin that is a solid at room temperature is usable as the resin constituting the metal-containing resin particles 20. The B-stage represents a state in which at least a part of the thermosetting resin has not set, and the unset portion melts when a predetermined heat is applied thereto. As the B-stage thermosetting resin, epoxy resin, polyimide resin, phenol resin, and so on are available, and a charge control agent may be added when necessary.

As shown in FIG. 4, the metal-containing resin particle 20 is essentially composed of B-stage thermosetting resin 20a which contains conductive metal particles 20b with a diameter of, for example, 0.6 μm or smaller at a rate of 10 wt % to 90 wt % substantially uniformly dispersed therein. The content of the conductive metal particulates 20b contained in the metal-containing resin particle 20 is more preferably 30 wt % to 70 wt %, and still more preferably 40 wt % to 60 wt %. Here, at least one kind of metal particulate selected from a group consisting of Pt, Pd, Cu, Au, Ni, and Ag is desirably used as the conductive metal particles 20b. These metal particulates will be nuclei of electroless plating which will be described later and act as a catalyst on the progress of plating reaction. Among these metal particulates, the use of Pd is especially desirable.

Next, the visible image (pattern) formed of the metal-containing resin particles 20 on the surface of the photosensitive drum 200 is electrostatically transferred from the photosensitive drum 200 onto the desired base material 11 by means of the transfer unit 204. The metal-containing resin particles 20 remaining on the surface of the photosensitive drum 200 after this transfer are removed and collected by a not-shown cleaning unit.

Subsequently, the B-stage metal-containing resin particles 20 transferred onto the base material 11 are passed through the resin curing unit 205 by heating or light irradiation for the thermosetting resin contained in the metal-containing resin particles 20 to melt and cure, thereby forming the metal-containing resin layer 12 in which the metal-containing resin particles 20 are integrated. Since this metal-containing resin layer 12 has no conductivity, the metal-containing resin layer 12 is immersed into the Cu electroless plating tank 207, and the above-described conductive metal particles 20b are used as nuclei to selectively precipitate Cu on the metal-containing resin layer 12, thereby forming the conductor metal layer 13. In this way, a conductor pattern excellent in conductivity can be formed. Note that a plating tank composed only of the electroless plating tank 207 is illustrated here, but it is not limited to this, and a plating tank may be employed which performs both electroless plating and electrolytic plating.

For efficient electroless plating, it is adoptable to perform processing of projecting at least part of the metal particles 20b from the surface of the metal-containing resin layer 12 in the resin etching unit 206 before the metal-containing resin layer 12 is subjected to the plating. The resin etching unit 206 is for removing by etching a portion of the resin on the surface of the metal-containing resin layer 12, in which the surface of the metal-containing resin layer 12 is immersed in an etching solution, for example, a solvent such as acetone, acid, alkali, or the like to be chemically removed by etching. In addition to the chemical removal by etching, the resin etching unit 206 can polish the portion of the resin through shotblasting or airblasting to thereby mechanically remove it by etching.

Note that when the metal-containing resin layer 12 is not yet completely cured, the resin on the surface of the metal-containing resin layer 12 can be removed during the plating by employing an alkaline plating solution, whereby the plating is accomplished. This eliminates the necessity of removal by etching by the resin etching unit 206. The thickness of the conductor metal layer 13 to be formed on the surface of the metal-containing resin-layer 12 can be controlled by plating conditions. After the plating, it is desirable that the base material 11 and the metal-containing resin layer 12 are brought into contact more closely, and heating or light irradiation is applied thereto by the resin curing unit 205 to completely cure the metal-containing resin layer 12 so as to prevent peeling and so on.

The preferable diameter of the metal-containing resin particles 20 is 5 μm to 10 μm in forming the conductor pattern as described above. In forming the conductor pattern, since the conductive metal particles 20b in the metal-containing resin particle 20 only need to serve as nuclei of the electroless plating and a wiring pattern has to be microscopically formed, the smaller diameter of the metal-containing particle 20 is the more preferable. For example, when epoxy resin particles with a diameter of 10 μm containing Pd particulates were used and a laser irradiating unit having about 600 dpi precision and a photosensitive drum unit were employed, it was possible to form a microscopic conductor wiring pattern with line/space=100 μm/100 μm. Further, when epoxy resin particles with a diameter of 5 μm containing Pd particulates were used and a laser irradiating unit having about 1200 dpi precision and a photosensitive drum unit were employed, it was possible to form a microscopic conductor wiring pattern with line/space=30 μl/30 μm.

Next, the forming process of the insulating pattern will be described referring to FIG. 3.

The photosensitive drum 200 is first uniformly charged, by the electrifier 201, while being rotated in a direction with an arrow so that its surface has a certain potential (for example, minus charges). Next, the laser generation/scan unit 202 irradiates the photosensitive drum 200 with the laser light 202a in accordance with an image signal to remove the minus charges on a portion irradiated, thereby forming an image of charges (electrostatic latent image) in a predetermined pattern on the surface of the photosensitive drum 200.

Next, to the electrostatic latent image on the photosensitive drum 200, charged resin particles 22 stored in the developing unit 203 are electrostatically attached by the supply mechanism to form a visible image. In this event, charged area development or reversal development can be employed. As the developing unit 203, a dry or wet toner transfer technique in a well-known electrophotographic copying system is applicable.

When the developing unit 203 is of the dry type, it stores therein the resin particles 22 with a diameter of 3 μm to 50 μm. The diameter of the resin particles 22 is more preferably 8 μm to 15 μm. On the other hand, when the developing unit 203 is of the wet type, it stores therein the resin particles 22 with a diameter of 3 μm or smaller. In forming the insulating pattern, insulation thickness is preferably large in view of electric insulation and accordingly, the diameter of the resin particles 22 is larger than that of the metal-containing resin particles 20.

B-stage thermosetting resin that is a solid at room temperature is usable as the resin constituting the resin particles 22. As the B-stage thermosetting resin, epoxy resin, polyimide resin, phenol resin, and so on are available, and a charge control agent may be added when necessary. Further, particulates of silica or the like contained at a predetermined rate may be dispersed in the resin particle 22, whereby characteristics such as stiffness, thermal expansion coefficient, and so on can be controlled, in particular, in a multilayer wiring board to enhance reliability of the board.

The visible image (pattern) formed of the resin particles 22 on the surface of the photosensitive drum 200 is electrostatically transferred from the photosensitive drum 200 onto a desired base material 11 by means of the transfer unit 204. The resin particles 22 remaining on the surface of the photosensitive drum 200 after this transfer are removed and collected by the not-shown cleaning unit.

Subsequently, the B-stage resin particles 22 transferred onto the base material 11 are passed through the resin curing unit 205 by heating or light irradiation for the resin particles 22 containing the B-stage thermosetting resin to melt and cure, thereby forming the resin layer 14 in which the resin particles 22 are integrated.

In this way, an insulating pattern excellent in thermal, mechanical, and environment-proof characteristics can be formed on the base material 11 for wiring board formation. Further, both in the conductor pattern forming process and the insulating pattern forming process, resin mainly composed of the B-stage thermosetting resin can be easily removed by a solvent or the like if it is before the thermosetting resin is cured by heating or light irradiation, so that the removal or correction of the pattern is possible.

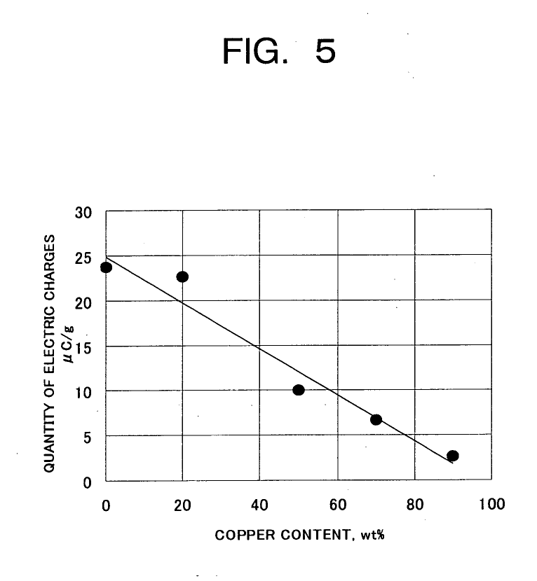

Next, details of determination that-the content of the metal particles 20b contained in the metal-containing resin particle 20 is 10 wt % to 90 wt % will be described with reference to FIG. 5. FIG. 5 shows the relation between the quantity of electric charges (μC/g) of the metal-containing resin particle 20 and the content of copper (wt %) contained in the metal-containing resin particle 20.

In the electrophotographic system, an electrostatic latent image which becomes positively or negatively charged is formed on the photosensitive drum 200, and the metal-containing resin particles 20 having charges are electrostatically attached to this electrostatic latent image. In this event, when the charge which the metal-containing resin particles 20 has (the quantity of electric charges) is small, the metal-containing resin particles 20 do not attach onto the photosensitive drum 200 or otherwise attaches to a position deviating from the electrostatic latent image pattern. On the other hand, when the quantity of electric charges is large, the resolution becomes better, but the number of the metal-containing resin particles 20 attachable to the photosensitive drum 200 is decreased, resulting in decreased image density. For these reasons, it is necessary to control the quantity of electric charges of the metal-containing resin particles 20 in order to form the conductor pattern with high accuracy.

Hence, a plurality of metal-containing resin particles different in copper content were produced by way of trial, each of which was mainly composed of epoxy resin and contains Cu particulates: with an average diameter of about 0.6 μm substantially uniformly dispersed in the epoxy resin, and the relation between the quantity of electric charges (μC/g) and the copper content (wt %) was examined.

The contents of copper contained in the metal-containing resin particles used in test are 0 (resin only), 20, 50, 70, and 90 wt %. Note that the test was conducted with external additive addition conditions adjusted such that the quantity of electric charges of the metal-containing resin particles becomes the highest.

The measurement result shows that the quantity of electric charges of the metal-containing resin particle decreases in a manner of substantially a linear function with an increase in copper content. Further, when the quantity of electric charges reached 2 μC/g or lower, the resolution on the photosensitive drum 200 significantly degraded, so that the formation of the conductor pattern was impossible. When the copper content reached less than 10 wt %, the conductor pattern was deteriorated in plating precipitating property, so that the formation of the conductor layer was impossible.

Based on these experimental results, the content of the metal particulates 20b is determined as 10 wt % to 90 wt %, the more preferable content is 30 wt % to 70 wt % which brings the quantity of electric charges of the metal-containing resin layer 12 and the plating precipitating property of the plating layer to be formed on the metal-containing resin layer 12 into balance, and the still more preferable content is 40 wt % to 60 wt %.

As described above, for the wiring board 10 of the first embodiment, the conductor pattern containing the conductive metal particles 20b is formed by the electrophotographic system and subjected to processing of projecting at least part of the metal particles 20b from the surface of the metal-containing resin layer 12, for example, in the resin etching unit 206, and plating can be performed using the projecting metal particles 20b as plating nuclei. Consequently, these metal particles 20b will act as a catalyst on the progress of plating reaction, so that the wiring board 10 can be obtained in which the conductor metal layer 13 in a preferable state is suitably formed on the surface of the metal-containing resin layer 12.

The content of the metal particles 20b contained in the metal-containing resin layer 12 set to fall within a predetermined range makes it possible to form the conductor pattern with the metal-containing resin layer 12 having an optimum quantity of electric charges, and to improve the plating precipitation property of the plating layer to be formed on the metal-containing resin layer 12 to thereby form an optimum conductor metal layer 13.

By sequentially performing the step of forming the metal-containing resin layer 12 containing the metal particles 20b by the electrophotographic system and further forming the conductor metal layer 13 on the metal-containing resin layer 12 by performing electroless plating, and the step of forming the resin layer 14 by a similar electrophotographic system, the wiring board 10 can be formed without using an exposure mask.

Further, since the wiring board 10 is directly formed based on digitalized design data, a reduction in cost and manufacturing time can be attained. Further, the forming process of the wiring board 10 is suitable for diversified small-quantity production.

Moreover, neither the use of photosensitive resin as the resin for pattern formation is necessary, nor resin having printability such as thixotropy and viscosity is particularly necessary. Therefore, the degree of freedom in physicality values (for example Young's modulus, transition temperature of glass Tg, hygroscopicity, and so on) of the resin is high, and as a result, reliability can be enhanced. Further, owing to the use of the B-stage thermosetting resin and the excellent thermal characteristics after the resin layer is cured, it is possible to obtain a wiring board which fully satisfies heat resistance at a normal soldering temperature (about 220° C. to about 260° C.).

It is also possible to use a low-cost circuit board manufactured by a conventional method (for example, a buildup substrate) as the base material and to form the conductor pattern thereon in the same manner as in the first embodiment. Further, in manufacturing substrates not requiring heat resistance such as connector wiring boards, thermoplastic resin such as acrylic resin is usable instead of the B-stage thermosetting resin.

It should be noted that the method of electrostatically transferring the metal-containing resin particles 20 or resin particles 22 onto the base material 11 by the transfer unit 204 through use of the electrophotographic system for the forming process of the conductor pattern or the insulating pattern is described here, but the present invention is not limited to this transfer method. For example, it is also adoptable that the manufacturing apparatus includes an intermediate transfer drum and a heating unit for intermediate transfer base instead of the transfer unit 204, and a metal-containing resin layer or a resin layer softened by the heating unit for intermediate transfer base is brought into contact with and pressed onto, as it is in the softened state, a desired base material from the intermediate transfer drum, whereby it is transferred owing to tackiness of the metal-containing resin layer or the resin layer.

(Second Embodiment)

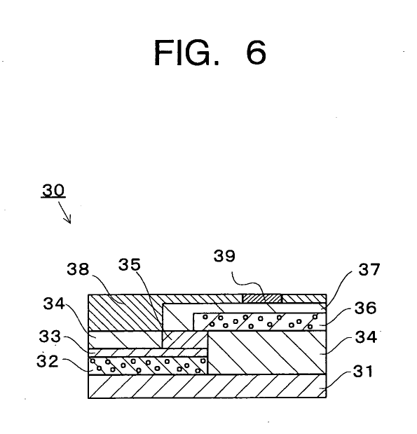

FIG. 6 shows a cross-sectional view of a multilayer wiring board 30 of a second embodiment formed by alternating-the above-described conductor pattern forming process and insulating pattern forming process. Note that the same reference numerals are assigned to the same portions as those in the configuration of the wiring board 10 of the first embodiment and the explanation thereof will be omitted. The multilayer wiring board 30 of the second embodiment is formed by the electrophotographic system in the similar manner to the wiring board 10 of the first embodiment.

A first layer constituting the multilayer wiring board shown in FIG. 6 is composed of a base material 31, a nonconductive metal-containing resin layer 32 selectively formed on the base material 31, a conductive conductor metal layer 33 formed on the metal-containing resin layer 32, a resin layer 34 selectively formed on the base material 31 and the conductor metal layer 33, and a via layer 35 formed in a recessed portion which is constituted by the conductor metal layer 33 and the resin layer 34. Further, a second layer formed on the first layer is composed of a metal-containing resin layer 36 selectively formed on the resin layer 34 and the via layer 35, a conductive conductor metal layer 37 formed on the metal-containing resin layer 36 and the via layer 35, a resin layer 38 selectively formed on the resin layer 34 and the conductor metal layer 37, and a via layer 39 formed in a recessed portion which is constituted by the conductor metal layer 37 and the resin layer 38.

Note that the above-described configuration can be further layered to form a third layer and a fourth layer.

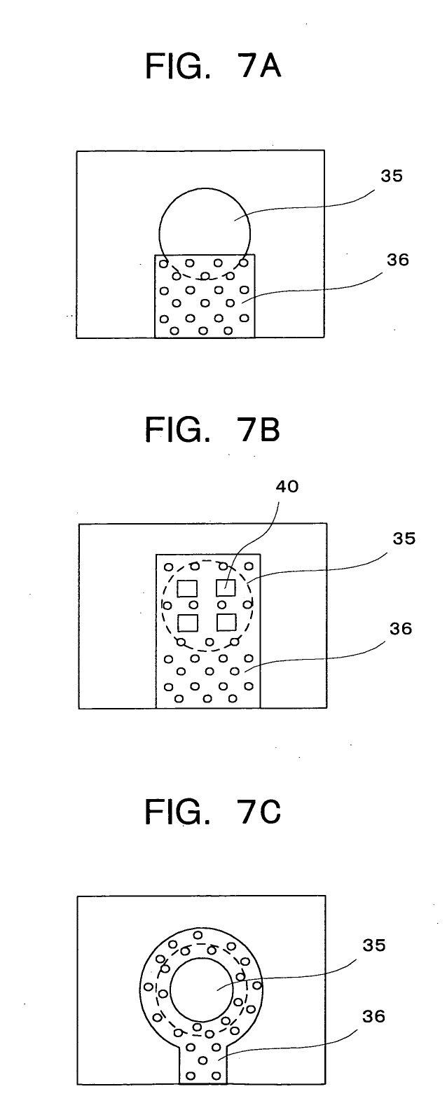

The above-described metal-containing resin layer only needs to be located in contact with a part of the via layer, and examples of the shape of the metal-containing resin layer formed on the via layer will be described with reference to plan views seen from above the via layer 35 shown in FIGS. 7A to 7C.

In the example shown in FIG. 7A, the metal-containing resin layer 36 is located to overlap a part of the top of the via layer 35.

In the example shown in FIG. 7B, the metal-containing resin layer 36 is located to cover the via layer 35, and the metal-containing resin layer 36 is formed with at least one communication hole 40 which communicates with the top of the via layer 35.

In the example shown in FIG. 7C, the metal-containing resin layer 36 is located around the via layer 35 in a manner to overlap the peripheral portion of the via layer 35.

As in the examples shown in FIGS. 7A to 7C, the metal-containing resin layer 36 only needs to be located in contact with a part of the via layer 35. Note that since the metal-containing resin layer 36 is nonconductive, it is necessary to electrically connect the via layer 35 with the conductor metal layer 37 formed on the metal-containing resin layer 36. Accordingly, the via layer 35 has at least a portion which is not covered with the metal-containing resin layer 36, and a conductor portion which electrically connects the conductor metal layer 37 and the via layer 35 is formed at the portion, for example, by electroless plating.

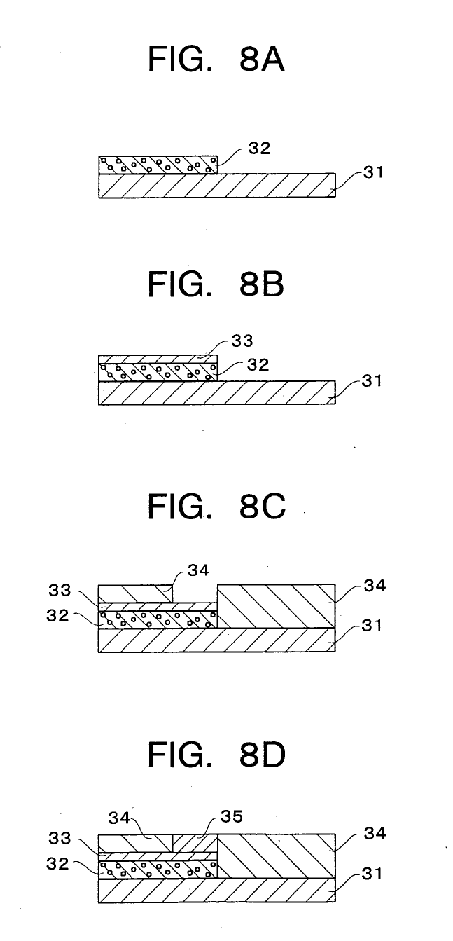

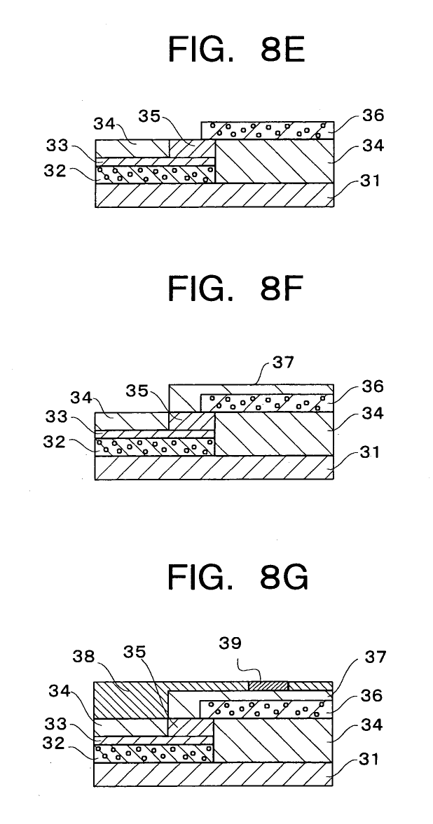

Next, an example of the forming process of the multilayer wiring board 30 having the via layer will be described referring to FIGS. 8A to 8G. FIGS. 8A to 8G show cross-sectional views showing the forming process of the multilayer wiring board 30.

The metal-containing resin layer 32 is formed in a predetermined conductor pattern on the base material 31 (FIG. 8A). Subsequently, for example, etching is performed for the surface of the metal-containing resin layer 32 to project at least part of conductive metal particles 20b contained in the metal-containing resin layer 32, and electroless plating is performed, thereby forming the conductor metal layer 33 composed of a plating layer such as Cu on the surface of the metal-containing resin layer 32 (FIG. 8B).

The resin layer 34 is formed within a region on the conductor metal layer 33 except a part where the via layer 35 is to be formed and on the base material 31 (FIG. 8C).

Electroless plating is performed for the recessed portion for forming the via layer 35 on the conductor metal layer 33 to form the via layer 35 (FIG. 8D).

Subsequently, to form the second layer, the metal-containing resin layer 36 is formed in a predetermined conductor pattern on a region of a part overlapping the via layer 35 and on the resin layer 34 (FIG. 8E).

For example, etching is performed for the surface of the metal-containing resin layer 36 formed on the region of the part overlapping the via layer 35 and on the resin layer 34 to project at least part of the conductive metal particles 20b contained in the metal-containing resin layer 36. Then, electroless plating is performed to form the conductor metal layer 37 composed of a plating layer on the surface of the metal-containing resin layer 36 and on the surface of the via layer 35 (FIG. 8F).

Subsequently, the resin layer 38 is formed within a region on the conductor metal layer 37 except a part where the via layer 39 is to be formed and on the resin layer 34 (FIG. 8G).

Thereafter, a step, similar to the step shown in FIG. 8D, of performing electroless plating for the recessed portion for forming the via layer 39 on the conductor metal layer 37 to form the via layer, is performed and further the step shown in FIG. 8D to the subsequent steps are repeated to form the multilayer wiring board 30 having the via layers.

As described above, the multilayer wiring board 30 in any design can be formed by alternately repeating the conductor pattern process and the insulating pattern process.

As described above, for the multilayer wiring board 30 of the second embodiment, the conductor pattern containing the conductive metal particles 20b such as Pd is formed by the electrophotographic system and subjected to processing of projecting at least part of the conductive metal particles 20b from the surface of the metal-containing resin layer 32 or 36, for example, in the resin etching unit 206, and plating can be performed using the projecting metal particles 20a as plating nuclei. Consequently, these metal particles 20b will act as a catalyst on the progress of plating reaction, so that the multilayer wiring board 30 can be obtained in which the conductor metal layers 33 and 37 in a preferable state are suitably formed on the surfaces of the metal-containing resin layers 32 and 36.

By sequentially performing the step of forming the metal-containing resin layer 32 or 36 containing the metal particles 20b by the electrophotographic system and further forming the conductor metal layer 33 or 37 on the metal-containing resin layer 32 or 36 by performing electroless plating, and the step of forming the resin layer 34 or 38 by a similar electrophotoqraphic system, the multilayer wiring board 30 can be formed without using an exposure mask.

Further, since the multilayer wiring board 30 is directly formed based on digitalized design data, a reduction in cost and manufacturing time can be attained. Further, the forming process of the multilayer wiring board 30 is suitable for diversified small-quantity production.

Moreover, neither the use of photosensitive resin as the resin for pattern formation is necessary, nor resin having printability such as thixotropy and viscosity is particularly necessary. Therefore, the degree of freedom in physicality values (for example, Young's modulus, transition temperature of glass Tg, hygroscopicity, and so on) of the resin is high, and as a result, reliability can be enhanced. Further, owing to the use of the B-stage thermosetting resin and the excellent thermal characteristics after the resin layer is cured, it is possible to obtain the multilayer wiring board 30 which fully satisfies heat resistance at a normal soldering temperature (about 220° C. to about 260° C.).

It should be noted that the method of manufacturing the multilayer wiring board 30 by alternating the insulating pattern formation and the conductor pattern formation is described in the second embodiment. On the other hand, even when at least one of the insulating pattern forming process and the conductor pattern forming process is performed in the same manner as in the first embodiment, and the other is performed by a different well-known method (screen printing, ink jetting, or the like), it is also possible to produce sufficient effects.

A substrate or a sheet formed of PTFE resin is used as the base material 31, the conductor pattern and the insulating pattern are alternately formed thereon in the same manner as in the-second embodiment, and thereafter a portion corresponding to thus formed multilayer wiring is removed from the base material 31, whereby a flexible multilayer circuit wiring board can be manufactured.

It is also adoptable to use a low-cost circuit board manufactured by a conventional method (for example, a buildup substrate) as the base material 31 and to form the conductor pattern thereon in the same manner as in the second embodiment. Further, in manufacturing substrates not requiring heat resistance such as connector wiring boards, thermoplastic resin such as acrylic resin is usable instead of the B-stage thermosetting resin.

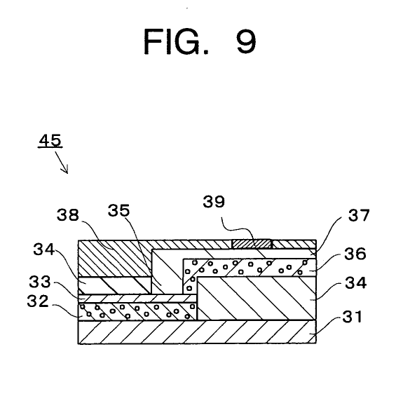

Note that the multilayer wiring board 30 of the second embodiment can employ the configuration of a multilayer wiring board 45 as shown in FIG. 9. In this drawing, the same numerals are assigned to the same portions as those in the configuration of the multilayer wiring board 30.

In the multilayer wiring board 45 shown in FIG. 9, the metal-containing resin layer 36 which is formed in a predetermined conductor pattern on the resin layer 34 is formed also in the recessed portion in which the via layer 35 is to be formed. Then, concurrently with formation of the conductor metal layer 37 on the metal-containing resin layer 36, the via layer 35 is formed. This can omit the step of independently forming the via layer 35, resulting in further reduction in the manufacturing time.

(Third Embodiment)

FIG. 10 shows a cross-sectional view of a multilayer wiring board 50 of a third embodiment formed by alternating the above-described conductor pattern forming process and insulating pattern forming process. Note that the same reference numerals are assigned to the same portions as those in the configuration of the first and second embodiments and repeated explanation thereof will be omitted. The multilayer wiring board 50 of the third embodiment is formed by the electrophotographic system as in the first and second embodiments.

The multilayer wiring board 50 shown in FIG. 10 includes a base material 51 having at least one through hole 57 opened, nonconductive metal-containing resin layers 52 selectively formed on the front and rear faces of the base material 51, conductive conductor metal layers 53 formed on the metal-containing resin layers 52, and a conductor portion 54 provided in the through hole 57 which electrically connects the respective conductor metal layers 53 formed on the front and rear faces. The multilayer wiring board 50 further includes resin layers 55 selectively formed on the base material 51 and the conductor metal layers 53, and via layers 56 formed in recessed portions which are constituted by the conductor metal layers 53 and the resin layers 55.

Note that the above-described configuration can be further layered to form the multilayer wiring board.

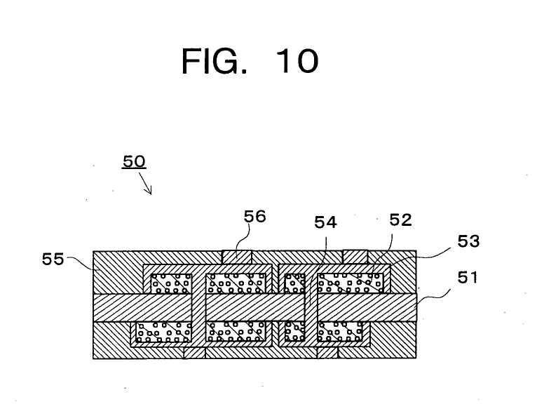

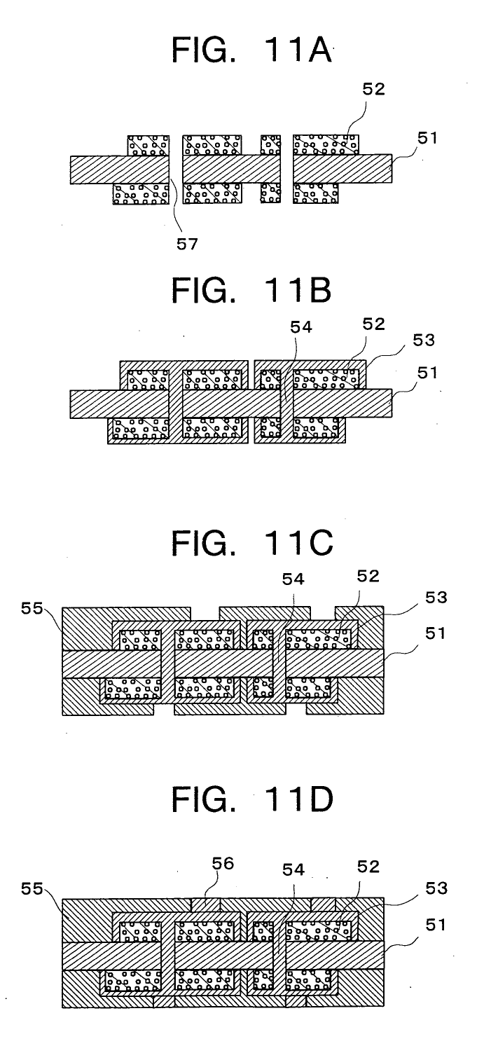

Next, an example of the forming process of the multilayer wiring board-50 will be described referring to FIGS. 11A to 11D. FIGS. 11A to 11D show cross-sectional views showing the forming process of the multilayer wiring board 50.

The metal-containing resin layers 52 are formed in a predetermined conductor pattern on the front and rear faces of the base material 51 having the through hole 57 opened (FIG. 11A).

Subsequently, for example, etching is performed for the surfaces of the metal-containing resin layers 52 to project at least part of conductive metal particles 20b contained in the metal-containing resin layers 52, and electroless plating is performed, thereby forming conductor metal layers 53 composed of a plating layer such as Cu on the surfaces of the metal-containing resin layers 52. Further, the conductor portion 54 which electrically connects with the respective conductor metal layers 53 formed on the front and rear faces of the base material 51 is formed in the through hole 57 (FIG. 11B).

The resin layers 55 are formed within regions on the conductor metal layers 53 except parts where the via layers 56 are to be formed and on the base material 51 (FIG. 1C).

Electroless plating is performed for the recessed portions for forming the via layers 56 on the conductor metal layers 53 to form the via layers 56 (FIG. 1D).

As described above, the multilayer wiring board 50 in any design can be formed by alternately repeating the conductor pattern process and the insulating pattern process. Further, it is also possible that a metal-containing resin layer is formed in a predetermined conductor pattern on the multilayer wiring board 50 shown in FIG. 11D, for example, etching is performed for the surface of the metal-containing resin layer to project at least part of conductive metal particles 20b contained in the metal-containing resin layer, and electroless plating is performed, thereby forming a conductor metal layer on the metal-containing resin layer. Moreover, it is also possible that a resin layer is formed within a region on the conductor metal layer except a part where a via layer is to be formed and on the resin layer 55, and electroless plating is performed for a recessed portion for forming the via layer on the conductor metal layer, thereby forming the via layer. In this way, layers each composed of the metal-containing resin layer, the conductor metal layer, the resin layer, and the via layer are layered, whereby a wiring board having more layers can be formed.

Note that the multilayer wiring board 50 having multilayer wirings layered on the front and rear faces of the base material 51 is described here, but the multilayer wiring may be formed only on one face of the base material 51. When the multilayer wiring is formed only on one face of the base material 51, the electrical connection between the one face side and the other face side is established by the conductor portion 54.

As described above, for the multilayer wiring board 50 of the third embodiment, the conductor patterns containing the conductive metal particles 20b are formed by the electrophotographic system and subjected to processing of projecting at least part of the conductive metal particles 20b such as Pd from the surfaces of the metal-containing resin layers 52, for example, in the resin etching unit 206, and plating can be performed using the projecting metal particles 20b as plating nuclei. Consequently, these metal particles 20b will act as a catalyst on the progress of plating reaction, and the multilayer wiring board 50 can be obtained in which the conductor metal layers 53 in a preferable state are suitably formed on the surfaces of the metal-containing resin layers 52.

By sequentially performing the step of forming the metal-containing resin layers 52 containing the metal particles 20b by the electrophotographic system and further forming the conductor metal layers 53 on the metal-containing resin layers 52 by performing electroless plating, and the step of forming the resin layers 55 by a similar electrophotographic system, the multilayer wiring board 50 can be formed without using an exposure mask.

Further, the multilayer wirings formed on the front and rear faces of the base material 51 can be formed with higher accuracy and produced more easily to thereby enable improved yields in forming the multilayer wiring board 50 having the conductor portion 54 through the base material 51 from the front face to the rear face.

Further, since the multilayer wiring board 50 is directly formed based on digitalized design data, a reduction in cost and manufacturing time can be attained. Further, the forming process of the multilayer wiring board 50 is suitable for diversified small-quantity production.

Moreover, neither the use of photosensitive resin as the resin for pattern formation is necessary, nor resin having printability such as thixotropy and viscosity is particularly necessary. Therefore, the degree of freedom in physicality values (for example, Young's modulus, transition temperature of glass Tg, hygroscopicity, and so on) of the resin is high, and as a result, reliability can be enhanced. Further, owing to the use of the B-stage thermosetting resin and the excellent thermal characteristics after the resin layer is cured, it is possible to obtain the multilayer wiring board 50 which fully satisfies heat resistance at a normal soldering temperature (about 220° C. to about 260° C.).

It should be noted that embodiments of the present invention are not limited to the above-described ones, and any single layer wiring board and multilayer wiring board are included in the embodiments of the present invention as long as their conductor patterns are formed by the electrophotographic system using metal-containing resin particles which contain conductive metal particulates substantially uniformly in resin at a predetermined content. Besides, the embodiments of the present invention can be extended and changed within a scope of the technical spirit of the present invention, and the extended and changed embodiments are also included in the technical scope of the present invention.

It is to be understood that the present invention is not intended to be limited to the specific embodiments described with reference to the drawings and all changes which come within the meaning and range of equivalency of the claims are therefore intended to be embraced therein.

1. A wiring board formed by an electrophotographic system of transferring a visible image to a substrate, comprising:
a substrate to which a visible image is transferred;
a nonconductive metal-containing resin layer selectively formed on said substrate and containing metal particulates dispersed therein;
a conductive conductor metal layer formed on said metal-containing resin layer; and
a resin layer formed contiguously to said metal-containing resin layer on said substrate.

2. A wiring board according to claim 1,
wherein the resin constituting said metal-containing resin layer is thermosetting resin.

3. A wiring board according to claim 1,
wherein said metal particulates are made of at least one kind of metal selected from a group consisting of platinum, palladium, copper, gold, nickel, and silver.

4. A wiring board according to claim 1,
wherein said conductor metal layer is formed by performing either electroless plating or both electroless plating and electrolytic plating.

5. A multilayer wiring board formed by an electrophotographic system of transferring a visible image to a substrate, comprising:
a substrate to which a visible image is transferred;
a first nonconductive metal-containing resin layer selectively formed on said substrate and containing metal particulates dispersed therein;
a first conductive conductor metal layer formed on said first metal-containing resin layer;
a first resin layer formed contiguously to said first metal-containing resin layer on said substrate, and on said first conductor metal layer;
a first conductor portion formed in a recessed portion which is constituted by a surface of said first conductor metal layer as a bottom face and said first resin layer as a side face;
a second nonconductive metal-containing resin layer selectively formed on said first resin layer and on said first conductor portion and containing metal particulates dispersed therein;
a second conductive conductor metal layer formed extending from a top of said second metal-containing resin layer to a top of said first conductor portion;
a second resin layer formed contiguously to said second metal-containing resin layer on said first resin layer, and on said second conductor metal layer; and
a second conductor portion formed in a recessed portion which is constituted by a surface of said second conductor metal layer as a bottom face and said second resin layer as a side face.

6. A multilayer wiring board formed by an electrophotographic system of transferring a visible image to a substrate, comprising:
a substrate which is formed with a through hole at a predetermined position and to which a visible image is transferred;
a first nonconductive metal-containing resin layer selectively formed at least on one face of said substrate and containing metal particulates dispersed therein;
a first conductive conductor metal layer formed on said first metal-containing resin layer;
a first conductor portion which electrically connects said first conductor metal layer formed on the one face of said substrate to another side of said substrate through said through hole;
a first resin layer formed contiguously to said first metal-containing resin layer on said substrate, and on said first conductor portion;
a second conductor portion formed in a recessed portion which is constituted by a surface of said first conductor metal layer as a bottom face and said first resin layer as a side face;
a second nonconductive metal-containing resin layer selectively formed on said first resin layer and on said second conductor portion and containing metal particulates dispersed therein;
a second conductive conductor metal layer formed extending from a top of said second metal-containing resin layer to a top of said second conductor portion;
a second resin layer formed contiguously to said second metal-containing resin layer on said first resin layer, and on said second conductor metal layer; and
a third conductor portion formed in a recessed portion which is constituted by a surface of said second conductor metal layer as a bottom face and said second resin layer as a side face.

7. A multilayer wiring board according to claim 5 or claim 6,
wherein the resin constituting said metal-containing resin layer is thermosetting resin.

8. A multilayer wiring board according to claim 5 or claim 6,
wherein said metal particulates are made of at least one kind of metal selected from a group consisting of platinum, palladium, copper, gold, nickel, and silver.

9. A multilayer wiring board according to claim 5 or claim. 6,
wherein said conductor metal layer is formed by performing either electroless plating or both electroless plating and electrolytic plating.
